(19) United States
(12) Patent Application Publication
(10) Pub. No.: US 2015/0186826 A1
(43) Pub. Date: Jul. 2, 2015

(54) Method for Determining an Optimal Mode of Operation and for Operating a Portfolio of Technical Equipment

(71) Applicant: am-tech switzerland ag, Rafz (CH)

(72) Inventors: Jörg SIGRIST, Bulach (CH); Christoph HEITZ, Elgg (CH); Sabina KLEGER, Winterthur (CH)

(73) Assignee: am-tech switzerland ag, Rafz (CH)

(21) Appl. No.: 14/469,090

(22) Filed: Aug. 26, 2014

(30) Foreign Application Priority Data
Sep. 2, 2013 (CH) 01492/13

(51) Int. Cl. G06Q 10/06

(52) U.S. Cl. CPC G06Q 10/06315

(57) ABSTRACT

The inventive disclosure relates to a method for determining the optimal modes of operation for the operating assets in a portfolio of technical operating assets. With this method, portfolios of resources, particularly those that produce a non-monetary benefit, and in particular public sector network infrastructure, can be optimally operated in the long term. The method is based on the identification of possible combinations of modes of operation (rules) of the portfolio of all operating assets over their entire or remaining service life, and on a benefit and resource usage function defined at the portfolio level. The method results in the identification, for each respective reporting asset, of the mode of operation that either causes the maximum benefit with lowest total resource usage or that has the minimal resource usage to achieve a given benefit. A resource usage-benefit relationship can be derived for the total portfolio.

### CROSS-REFERENCE TO RELATED APPLICATIONS

This patent application claims the priority benefit of Swiss Patent Application No. 01492/13, filed on Sep. 2, 2013, for “Method of determining an optimal mode of operation and for operating a portfolio of technical facilities.”

### BACKGROUND

The invention relates to a method for determining an optimal mode of operation of a portfolio of multiple pieces of technical operating assets that deliver a specific technical performance during their service life.

A portfolio of operating assets can for example be an infrastructure network, perhaps an electrical grid that consists of cable, lines, switches, transformers, etc. It can also be an industrial production facility or, in general, a collection of technical operating assets, the operation of which is of benefit to the portfolio owner.

A mode of operation is an instruction for how a single operating asset (piece of equipment) should be operated over its entire or remaining life cycle, and includes the specification of the replacement interval and/or the service life of the operating asset. In the simplest case a mode of operation of an operating asset specifies the service life of this operating asset. A mode of operation can however also contain an arbitrarily large number of other specifications for operation during the life cycle, e.g. type and frequency of maintenance, specifications for closed-loop or open-loop control, etc. It contains all the rules that guide the technical operation of the operational resource.

A combination of modes of operation is the combination of modes of operation for all the operating assets in the portfolio.

As a rule, an owner of a portfolio of technical operating assets has many different possibilities for operating each operating asset: he can provide for different service lives, he has different options for performing maintenance during the service life, he can load the operating assets to different degrees, and so on. Each combination of modes of operation calls for the use of resources such as energy and materials, but also financial resources to cover, for example, capital costs, maintenance costs, or other life cycle costs. At the same time the combination of modes of operation creates a specific technical behavior of each individual operating asset, and thus also the portfolio of operating assets as a whole. As a rule this technical behavior pertains to the malfunction or failure behavior, but it can also be other technical performance metrics such as production output. Typically the owner desires a specific technical behavior of the total portfolio, for example the most malfunction-free operation possible or the shortest possible operational interruptions, or else a maximum availability and flexibility of the total portfolio. In the rarest of cases this can be broken down to the level of technical behavior of individual operating assets, but mostly it relates to a global behavior of the total system that is produced jointly by all operating assets.

The owner of the operating assets portfolio gains a specific benefit from operating the portfolio. In the case of a production network the benefit is the ability to make specific products with a specific quality in a specific time, whereby profit can be made in the market. For an infrastructure network such as an electricity supply grid, the benefit is a specific quality of supply. The benefit is, as a rule, a function (utility function) that is dependent on the technical behavior of the operating assets portfolio but typically also includes other, non-technical parameters.

A well-known example of a utility function in the area of infrastructure networks is, for example, the SAIFI metric (System average interruption frequency index) or SAIDI (system average interruption duration index). In the case of SAIFI the technical failure rate of individual operating assets is combined with their relative importance and the number of customers that are affected by a failure, and summed-up over the total system. In the case of SAIDI the downtime is also taken into account, which depends on both the technical characteristics of the operating assets and on organizational issues.

In the case of a production network the benefit for the owner is, on the one hand, dependent on technical behavior of the operating assets (e.g. frequency of failure, quality of production), and on the other hand also on the company's internal characteristics and on current market conditions.

Another well-known metric is the return on investment of a portfolio of technical facilities, which compares the achievable revenue from the portfolio of operating assets with the associated cost. The revenues and costs depend, in turn, on failure behavior, on other technical behavior, but also on external parameters.

The current benefit of a portfolio as measured by a predetermined utility function can change over time, because all input parameters can change over time. One influence is the operating assets age, which leads to the malfunction rate or failure rate increasing over time, and diminishes the technical performance. Maintenance and replacements should counteract this tendency.

The benefit of a portfolio of operating assets is thus particularly dependent on the mode of operation, because this influences the technical behavior. The portfolio owner is, as a rule, interested in maximizing the benefit. One of the input parameters that is most important in practice, and which can be controlled by the owner, is the optimal selection of the mode of operation.

However, in order to operate a portfolio of operating assets and thereby generate benefits, the owner must use financial and non-financial resources. Financial resource requirements arise, for example, in the form of investment costs, operating costs, or end-of-life disposal costs. A non-financial resource can be, perhaps, the time needed for maintenance staff to work. As a rule, all resources can be expressed in a common unit. Usually monetary units are used, but this is not required. In the context of this patent specification, we denote the resource requirements generally as “costs,” but these can be expressed in arbitrary units (for example time, money, energy, material, etc . . . ).

As a rule the portfolio owner is interested in minimizing costs.

Both the benefit and the costs are influences by the selection of a mode of operation of the individual operating assets. The facilities owner's decision problem is thus to find the optimal combination of modes of operation for the portfolio. In FIG. 14 this relationship is depicted graphically.

An important special case is the problem of finding the optimal combination of modes of operation for the individual operating assets of the portfolio, given a total budget of resources. This often arises in practice because in many situations the total budget of resources is not easily changeable. An example is in the area of public infrastructure, where the use of resources is, as a rule, measured in monetary units. Here the total resource budget is, as a rule, specified in a budget. Changes require complicated political processes, and as a rule it is not within the decision-making power of the actual operator (e.g. a municipal utility) to change the total budget. In the area of electrical power supply the situation is similar, even though the operators of a power supply network are often private firms. However, because the revenue side is controlled by a state regulator, it is enormously complicated in practice to change the total budget. In industrial production plants, the total budget is also, as a rule, set by the company management, and any changes require a discussion in the total context.

On the other hand, the allocation of the total resource budget to the different operating assets is a task that usually falls to an asset manager or maintenance manager, and this manager has considerable power over this decision. Therefore, one of the most important questions for these functions consists precisely in the question of how a given total resource budget should be optimally allocated.

Another special case consists of the task of finding the optimal combination of modes of operation, which achieves a certain predetermined long-term performance of the portfolio of operating assets. In this context, optimal means minimizing the total resource input. A production company that has specific requirements for its facilities portfolio, but must operate with the lowest possible long-term resource input, must solve this special case.

In practice a major difficulty is that resource usage and benefits are often expressed in different units. This is very pronounced in the case of operating assets portfolios that generate a predominantly non-financial benefit, but whose technical or material resource needs can be expressed in monetary units. Examples are all infrastructure networks such as power distribution, water supply, street or rail networks. The primary goal of these networks is not to enable a firm to make money, but rather they should guarantee the users of the infrastructure (the populace, as a rule) a qualitatively high-quality supply of energy, water, etc. The actual goal is therefore measured in metrics such as, for example, the SAIFI, but the costs are expressed in monetary units. In such a situation, where costs and benefits are expressed in different units, it is not clear what the optimal mode of operation of a portfolio actually is. Different modes of operations are distinguished by different costs, but also by different benefits. As a rule, higher resource inputs deliver a higher benefit. Without further conditions, it is not possible to definitively identify what is optimal.

There are approaches that monetize resource inputs as well as benefits and construct a target function in which both elements have influence. This can then be used as the optimization criterion. However it is often extremely difficult to express costs and benefits in a common, optimizable quantity, and therefore this is often not done.

For example, for supply infrastructure networks it is determined through political processes how much money the community makes available to spend on the facilities portfolio. If the supply quality appears too low, or if much money is available, more is invested.

In such a context it is important to define different options for both costs and benefits. An optimization and a discussion of variants then occur via an integrated consideration of these two variables, and require a deliberative discussion (cost-benefit analysis) that cannot be replaced by an optimization algorithm.

Existing methods for determining the optimal use of a portfolio of technical operating assets focus mostly on a one-dimensional goal that should be maximized or minimized.

There is a rich literature in the area of maintenance and physical asset management, which describes different methods for determining the optimal mode of operation for technical facilities. A reference of the current state of the art is Andrew Kennedy Skilling Jardine, Albert H. C. Tsang: Maintenance, Replacement, and Reliability: Theory and Applications, 2nd ed., CRC Press, 2013. In the methods described in the literature the key decision is, as a rule, reduced to a minimization of costs, wherein the operational benefits either are not considered, or are only outlined very broadly. A classic example is the consideration of operating assets failure as a reduction in benefits in the form of costs from lost production, which are added to the capital costs and maintenance costs. As a rule, costs from lost production are, indeed, a part of the benefit reduction, but often do not correctly model the benefit reduction. For example the costs from lost production in the area of electricity supply are so small that they are negligible when compared to the capital costs. A minimization of the total costs as a sum of capital, maintenance and failure costs would therefore bring with it a worsening of the quality of the electricity supply, which—at least in developed countries—would not be accepted by the general public. Therefore, the conventional methods, which were developed for the scenario of an industrial production operation, fail here. The underlying reason is that the optimization does not model the benefits of the operating assets at the level of the total system.

The merging of benefits and costs into a common goal, as per the methods described in the literature, has yet another disadvantage. The optimization process leads to a mode of operation that produces specific benefits and causes specific costs, but it is not possible to fix one of the two variables ahead of time. Therefore, the question of which mode of operation produces the maximum benefit for a given total cost is literally not answerable.

Moreover, the methods are not suitable for finding optimal modes of operation if resource input and benefits are expressed separately and in different dimensions, because they require a one-dimensional goal.

A further disadvantage of the methods described in the literature is that the total portfolio is not considered, but rather the analysis is performed at the level of individual operating assets. Typical aspects of the portfolio are therefore not considered. An important aspect of the portfolio is that the resource input to a facility A can perhaps be increased by simultaneous reduction of the same amount of resource input to facility B. This results in the same resource usage, but to different benefits. Methods that are built on a single facility view by their nature cannot consider such effects. The question of which combination of operating assets produces the smallest resource usage to reach a specified benefit cannot be answered by these methods.

In WO2013082724A1 a method is described with which maintenance decisions could be made for a portfolio of “capital investments”. Specifically, it is described how replacement time points for the individual operating assets can be determined, wherein the risk of moving the replacement time points into the future is taken into account. In contrast to the invention described in the present patent specification, it focuses on a purely financial optimization (Claim 1: “. . . determine a financially optimal replacement date”).

In the optimization neither the technical performance of the individual operating assets nor that of the total portfolio is explicitly considered as a function of the decisions. When measuring the risk of delaying a replacement time point, only the failure costs are considered (“the replacement deferral risk cost model estimating costs of failure”), but not the reduction of the total benefit because of the failure. Furthermore, neither a maximization of benefits is sought, nor can benefits and costs be formulated in different units.

A method that calculates the optimal maintenance actions for a portfolio of buildings is described in US2013/0124251A1. An optimization goal must be defined, comprising cost reduction, minimization of greenhouse gas emissions, or minimization of energy, or arbitrary combinations of these goals. A total budget can be specified as a constraint. A disadvantage of this method is that the service life of the operating assets (expressed by the time point of the retrofit action) must be set ahead of time. It is indeed possible to specify an optimal selection of predetermined maintenance actions, but with the method it is in principle not possible to optimize the mode of operation over the entire life cycle of the operating assets, in particular to specify the optimal time for a retrofit action.

In US2009177515A1 a method is described of carrying out interactive investment optimization with the goal of finding an optimal apportioning of an investment sum to different classes of infrastructure articles. Therein the effect of a specific partial investment on the condition of the operating assets is considered, and the influence of the conditions on the user is depicted as a criterion. Some disadvantages of this method are, among others, that the method is designed to be interactive so it is not possible to automatically derive the optimal combination of modes of operation, that a life cycle assessment is not present, and that the method only functions if an additional investment also leads to an improved condition. In particular, in practice and for a life cycle assessment, the last point is often not satisfied.

The existing methods comprise different disadvantages regarding the long-term operation of a portfolio of technical operating assets. A key problem has to do with the strong focus on the cost of the facilities and the imprecise modeling of the benefit that the operation of the portfolio generates, and that is dependent on the mode of operation. In particular for a portfolio whose benefit is predominantly non-monetary, such as network infrastructure, a cost minimization exercise does not deliver the optimal mode of operation. As a rule, the question of how a given total budget of resources can be optimally employed is not answered.

The tendency to focus on a partial solution to the task creates an additional problem. During known methods only replacement time points are considered and not the whole spectrum of all possible asset management actions over the entire life cycle (for example repairs, service, improvement and maintenance variants) or a preselection of these is carried out. Other methods have the disadvantage that the measurement of the effectiveness value of the action is performed on the individual facilities or classes of facilities, without considering the total portfolio as a whole.

In conclusion it can be determined that no method exists that, from all possible variants of a pool of technical facilities, automatically identifies those that are optimal under the given general conditions.

### BRIEF DESCRIPTION OF THE DRAWINGS

FIG. 1 describes one embodiment of the Steps of the method for determining an optimal mode of operation and for operating a portfolio of technical facilities.

FIG. 2 depicts an example of costs and benefits of different modes of operation.

FIG. 3 depicts examples of cost-benefit diagrams for two individual modes of operation.

FIG. 4 depicts examples of cost-benefit diagrams for two individual modes of operation, with the upper branch of the convex envelope of all points shown.

FIG. 5 depicts an example of additional resource usage ΔC and additional benefit ΔN along the upper branch.

FIG. 6 depicts examples of derivatives of utility functions for costs.

FIG. 7 depicts an example of the relationship between benefits and costs.

FIGS. 8 and 9 depict examples of sub-resource usages and sub-benefits of two operating assets for different modes of operation.

FIG. 10 depicts an example of a convex envelope of operating asset 1.

FIG. 11 depicts an example of a convex envelope of operating asset 2.

FIG. 12 depicts an example of convex envelopes of both operating assets 1 and 2.

FIG. 13 depicts an example of costs and benefits of a portfolio of technical facilities.

FIG. 14 provides an overview of the values used and calculated in the method for determining an optimal mode of operation and for operating a portfolio of technical facilities.

### DETAILED DESCRIPTION

### Overview

It is therefore the object of the invention to provide a method, a data processing system, and a computer program for determining an optimal mode of operation of a portfolio of multiple pieces of technical operating assets of the type mentioned above, which alleviates the disadvantages mentioned above and thereby makes possible, for example, the optimization of the technical characteristics of the portfolio.

This object is achieved by a method, a data processing system and a computer program for determining an optimal mode of operation of a portfolio of multiple pieces of technical operating assets.

The method for determining an optimal mode of operation of a portfolio of technical operating assets can comprise the following two or three steps.

The first step comprises four sub-steps.

Sub-Step i:

First, a set of possible combinations of modes of operation is defined for the portfolio of operating assets.

Sub-Step ii:

Then, a function is defined for each operating asset, which calculates for each mode of operation that appears in the set of possible combinations of modes of operation for this operating asset that was defined in sub-step i what the failure or malfunction rate of the operating asset is over its entire or remaining service life. Likewise, other technical performance metrics can be calculated in this sub-step, if they are of importance to the utility function that is described in the next sub-step.

Sub-Step iii:

In a third sub-step, each combination of modes of operation is assigned to a corresponding total benefit, which is dependent on the failure behavior of at least one operating asset (utility function). As a rule, the utility function is dependent on the failure behavior of all operating assets and can also be dependent on additional technical properties calculated in sub-step ii.

The utility function quantifies the benefits established via the operating asset portfolio, dependent on the selected combination of modes of operation and the technical performance thereby achieved.

Sub-Step iv:

In the last sub-step, each combination of modes of operation is assigned an associated total resource usage (resource usage function). The resource usage function describes the amount of resources used in total, which is also dependent on the chosen modes of operation of the operating assets.

The second step of the method comprises either assessing which combination of modes of operation maximizes the benefit of the portfolio, given a specific total resource budget, also called total budget (step 2a), or finding which combination of modes of operation minimizes the resources needed to generate a predetermined total benefit (step 2b). Step 2a provides the optimal mode of operation for each operating asset (within the constraint of the given total budget), as well as a statement of how high the maximum achievable benefit N is with the resource usage C that falls within the given total budget. As an alternative to this, step 2b provides the combination of modes of operation that minimize the resource usage C needed to achieve a predetermined benefit N that should be reached.

The combination of modes of operation that maximizes the total benefit or, respectively, minimizes the total resource need is displayed to the user. To achieve this, a solution of the optimization problem is displayed to a user by means of a output device or display device, in such a way that the associated optimal mode of operation is made visible for each operating asset. The output device can be a screen or a printer.

The third, optional step consists of repeatedly performing step 2a or step 2b, for different values of the total resource budget or the total benefit, and thus establishing different optimal points (C,N). These points are visualized graphically in such a way that the user can see the relationship between the benefit and the level of the input resources, in a resource-need-benefit function. Thus, a single diagram is produced, which represents all the Pareto-optimal combinations of modes of operation and their resource usages and benefits. With this representation the facilities' owner can perform a quantitative resource requirement-benefit analysis or cost-benefit analysis, and set the operating point of the total portfolio.

The described method enables operators of technical operating asset portfolios to establish those modes of operation for the operating assets that are optimal in the overall context. Here the term mode of operation relates to the entire life cycle of the operating assets. A mode of operation is an instruction for how an individual operating asset should be operated over its entire or remaining life cycle, and includes the specifications of replacement time points and/or the service life of the operating asset.

Advantages over known methods of physical asset management include the following characteristics:
The optimization includes the total system and in particular considers portfolio effects that are caused by reallocating resources from one operating asset to another.
Resource usage and benefits can be expressed in different units. It is not necessary to express both dimensions in a shared, e.g. monetary, unit.
The optimal mode of operation refers to the management over the entire life cycle, and not only to a one-time decision.
Resource usage and benefits are defined for the total system. Thus the dependencies that the operating assets have with respect to the resource needs or benefit generation are considered.
The question of the optimal use of a given total resource budget, which is very relevant in practice, is directly answered by step 1 and 2a of the method.

A further advantage is that with the method, the strategic organizational goals that are defined by the utility function can be directly translated into operative specifications. The invention thus allows the optimal realization of a holistic and seamless asset management of technical facilities.

The data processing system for determining an optimal mode of operation of a portfolio of multiple pieces of technical operating assets comprises storage means with computer programming code means stored therein, which describe a computer program, and data processing means for execution of the computer program, wherein the execution of the computer program leads to the implementation of the described method.

The computer program for determining an optimal mode of operation of a portfolio of multiple pieces of technical operating assets is able to be loaded into an internal memory of a digital data processing unit, and comprises computer programming code means, which, if they are executed in a digital data processing unit, bring about the execution of the described method. In a preferred embodiment of the invention, a computer program product comprises a data carrier or a computer-readable medium, on which the computer program code means is stored.

Further embodiments will be apparent from the balance of this Specification.

### Terminology

The following definitions are valid herein:
1. The utility function of the portfolio assigns a benefit to each combination of modes of operation. It is a function of the failure rate of at least one operating asset, possibly other technical performance factors that are influenced by the mode of operation, and possibly other non-technical factors. Therein, the behavior of all the parameters influencing the utility function over a specified future time period are considered, which time period can be limited or also arbitrarily long or endless. The utility function in particular depends on the modes of operation selected for the operating assets.
2. The cost function of the portfolio is a description of the resources necessary to operate the portfolio in a given combination of modes of operation. Therein, the same time period is considered as for the definition of the utility function.

### DETAILED DESCRIPTION WITH REFERENCES TO THE DRAWINGS

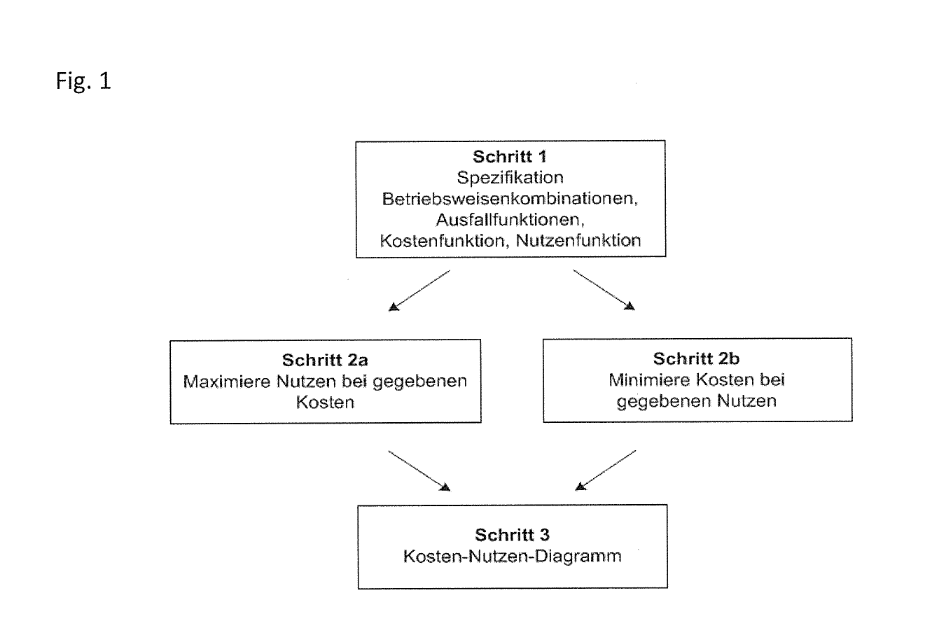

In FIG. 1 the steps of the method are represented graphically.

The division into these three steps has the following advantages:
The result from step 1 and 2a automatically supplies the answer to the question of how a total budget should be optimally allocated among the different operating assets, and how exactly these sub-budgets should be used. Thus, the central question of asset management can be answered. If the operating assets portfolio is operated with the calculated optimal combination of modes of operation, it is assured that the given total resource budget will not be exceeded, but the maximum benefit is always guaranteed. Thus, the technical behavior of the operating assets portfolio is manipulated such that the best possible result is obtained with regard to the utility function.
The result from step 1 and 2b automatically supplies the answer to the question of how many resources are needed in order to reach a predetermined total benefit, and how exactly these resources must be used.

If the portfolio is operated according to this calculated optimal combination of modes of operation, the technical use is thereby optimized such that the desired benefit is obtained with a minimum of resources.
The representation in step 3 integrates at the total system level the relationship between resource input and benefits achieved thereby, and thereby supplies an optimal representation for a cost-benefit analysis.

By the combination, therefore, the method ensures that in a situation where resource usage and benefits are influenced by the choice of modes of operation for the operating assets, the optimal mode of operation for each individual operating asset can be specified. In the case that either the total resources available to be used of the total benefit to be gained is already given, steps 1 and 2 already suffice.

In the following, possible realizations of the three steps will be described further and different embodiments outlined.

Step 1 (Specification of the Mode of Operation, the Failure Function, and the Utility and Resource Usage Function)

Sub-Step i:

In the first sub-step of step 1 of the method, first for each operating asset i (i=1, . . . N) a set of mᵢ different modes of operation is defined that are possible for this operating asset. The mᵢ different possible modes of operation for operating asset i are enumerated with the parameter jᵢ. The different modes of operation can determine; e.g., the service life, the manner and intensity of the maintenance during the service life, the manner and level of the operation of the operating assets, etc. One of the possible modes of operation can also represent the case that the operating assets is not even acquired and operated. Each mode of operation is described by a set of parameters.

There is a combination of individual modes of operation at the portfolio level. This combination of modes of operation is referred to with KW, wherein KW can be expressed by a vector that specifies the mode of operation calculated for each operating asset:

KW=(j₁, j₂, . . . , j_{N}), jᵢ∈[1,2, . . . ,mᵢ]

In the case that all modes of operation can be freely combined, the number #KW of different combinations is the product of the number of possible modes of operation of the individual operating assets:

#KW=m₁19 m₂· . . . ·m_{N}

In the case that not all combinations are possible, the number #KW is correspondingly reduced. The set of all possible combinations is referred to by Kw.

The specification of the combinations of modes of operation can for example be achieved by user input, or by reading a corresponding computer-readable representation from a data store, or by a computerized calculation program calculating the set of all possible combinations of modes of operation.

Sub-Step ii:

In the second sub-step for each operating asset a failure function is defined, which specifies how high the failure or error rate is given one of the combinations of modes of operation defined in sub-step i. Each combination of modes of operation is thus assigned for each operating asset i=1, . . . N a specific failure or malfunction rate that characterizes the failure or malfunction behavior of the operating asset under consideration. The failure or malfunction behavior changes over time based on aging of the operating asset. The failure function can therefore by described by, e.g., a hazard function:

Failure rate or malfunction rate, respectively=h(t, KW)

Therein h( ) identifies the failure rate or malfunction rate, respectively, dependent on the two parameters t (age of the operating asset) and KW (combination of modes of operation, or a parametric representation thereof).

The failure function can be defined by user input, or by reading a representation that has previously been saved in a computer storage, or by defining or reading from a data carrier a calculation rule that calculates the appropriate failure function from the specification of the mode of operation of the operating asset.

The failure or malfunction rate of the operating assets is an input for the sub-step iii, in which the utility function is defined.

Sub-Step iii:

In the third sub-step, a utility function is defined that defines the benefit that the operating assets portfolio produces under the selected combination of modes of operation:

N=N(KW), KW∈M_{KW}

The benefit is a scalar that depends on the technical performance of the operating assets (in particular the failure or malfunction behavior), which in turn is produced by the relevant mode of operation.

An important embodiment of the utility function is that the benefit of the total portfolio is modeled as a sum of the individual sub-benefits of the individual operating assets.

$$N ( KW ) = {\sum }_{i = 1}^{N} {N}_{i} ( {j}_{i} )$$

The utility function can be expressed in an arbitrary unit that does not need to correspond to the unit of the resource usage function.

In a variant of the method the benefit is defined as the negative of the weighted average failure rate of the operating assets:

$$N ( KW ) = - {\sum }_{i = 1}^{N} {γ}_{i} {\overline{h}}_{i} ( {j}_{i} )$$

where h̅ᵢ is the failure rate of the operating asset i under the chosen mode of operation jᵢ, averaged over the service life. Such an approach is used in risk management, where the weighting factory γᵢ represents the degree of damage caused by a failure. Here, a smaller risk corresponds to a higher benefit. Common quality metrics for infrastructure networks, such as, e.g., SAIDI or SAIFI, have this form.

In another embodiment, future benefits are discounted and summed over the entire future (net present value):

$$N ( KW ) = - {\sum }_{i = 1}^{N} {γ}_{i} {\sum }_{i = 0}^{∞} {h}_{i} ( {t}_{i} , {j}_{i} ) {α}^{t}$$

Here hᵢ(tᵢ,jᵢ) represents the failure rate of operating assets i of age tᵢ under the mode of operation jᵢ. The factor α<1 is a discount factor.

In a case where the total benefit at the portfolio level is not a simple sum of sub-benefits, the utility function can also take into account interactions between the different operating assets.

In a further variant, the benefit function, other technical performance metrics such as, e.g., production capacity or operational safety, or arbitrary combinations thereof, are taken into account.

The benefit function can be defined by user input, or by reading a representation that has previously been saved in a computer storage, or by defining or reading from a data carrier a calculation rule that calculates the appropriate failure function from the specification of the mode of operation of the operating asset.

Sub-Step iv:

A resource usage function C is defined, which indicates the resource usage of the portfolio, dependent on the selected combination of modes of operation KW:

C=C(KW), KW∈M_{KW}

As a rule the resource usage function is strongly time-dependent. The energy usage can perhaps increase over the service life due to wear and tear. The demand on employee time can also rise as a function of rising malfunction rates. In particular the demand on financial resources is strongly time-dependent. At the beginning of the service life, a large investment sum falls due, revisions are due at specific time points, and at the end of the service life, costs for disassembly and disposal fall due.

Therefore, the resource usage function, analogous to the utility function, is also time dependent. Important embodiments are therefore the time-averaged resource usage, or a net present value of the resource usage, analogous to the utility function.

According to an embodiment the sum of resource usages Cᵢ of the individual operating assets, averaged over their life expectancy, is used for C. As a rule, these are easy to determine if the mode of operation is fixed.

$$C = {\sum }_{i = 1}^{N} {C}_{i} ( {j}_{i} )$$

As an example, consider an operating asset in which the resource usage is identified with costs or, respectively, expressed as costs. Furthermore, to simplify the example it is assumed that only investment costs, maintenance costs, operating costs and capital gains play a role at the end of the service life. Let the mode of operation contain as its single parameter the service life T; i.e., the manner of operation is fixed, but there are various options for the service life. For each service life T the annual operating costs are denoted by Bk(T), and the yearly averaged maintenance costs by Ik(T), each calculated over the entire service life. The resale value at the end of the service life is denoted by—I2(T). Other sorts of resource usage are not considered. It should be noted that in this example and others that follow, resource usage is expressed in monetary values. However, this is not necessary—the resource usage can be expressed in arbitrary units; e.g., in energy units, man-hours, or others, depending on the case being considered.

In the present example, each mode of operation (characterized by the service life T) is associated with a resource usage (cost), which is calculated as the average yearly resource usage:

$${C}_{i} ( {T}_{i} ) = \frac{( {I}_{i} - I {2}_{i} ( {T}_{i} ) + {Bk}_{i} ( {T}_{i} ) + {Ik}_{i} ( {T}_{i} ) )}{{T}_{i}}$$

According to another embodiment, the resource usage for each operating asset is defined with discounted costs over the entire future:

$${C}_{i} ( {T}_{i} ) = {\sum }_{t = 1}^{∞} [ {I}_{i} ( {T}_{i} ) + I {2}_{i} ( {T}_{i} ) + {Bk}_{i} ( T ) + {Ik}_{i} ( {T}_{i} ) ] {α}^{t}$$

where α denotes the annual discount factor.

In general, the total resource usage is not simply a sum of the individual usages, but rather there may be interactions. For example, multiple operating assets that have the same life cycle can be replaced simultaneously, which normally results in lower costs than if the operating assets were operated independently from one another. Such interactions can be considered in the cost function C.

In the following variant of the definition of the total resource usage, such interactions are considered by means of interaction terms:

$$C = {\sum }_{i = 1}^{N} {C}_{i} ( {j}_{i} ) - {\sum }_{i , {i}^{′} = 1}^{N} {S}_{{ii}^{′}} ( {j}_{i} , {j}_{{i}^{′}} )$$

where denotes a synergy gain that is achieved by the combination of mode of operation jᵢ for operating asset i and for operating asset

The utility function can be expressed in an arbitrary unit that does not need to correspond to the unit of the resource usage function.

Step 2a (Optimal Combination of Modes of Operation for a Predetermined Total Resource Usage)

Let a predetermined total resource budget B be given that represents the permissible resource usage of the total portfolio. This can be, for example, a maximum energy usage or a maximum permissible cost. Step 2a consists of determining the combination of modes of operation that is optimal under this constraint.

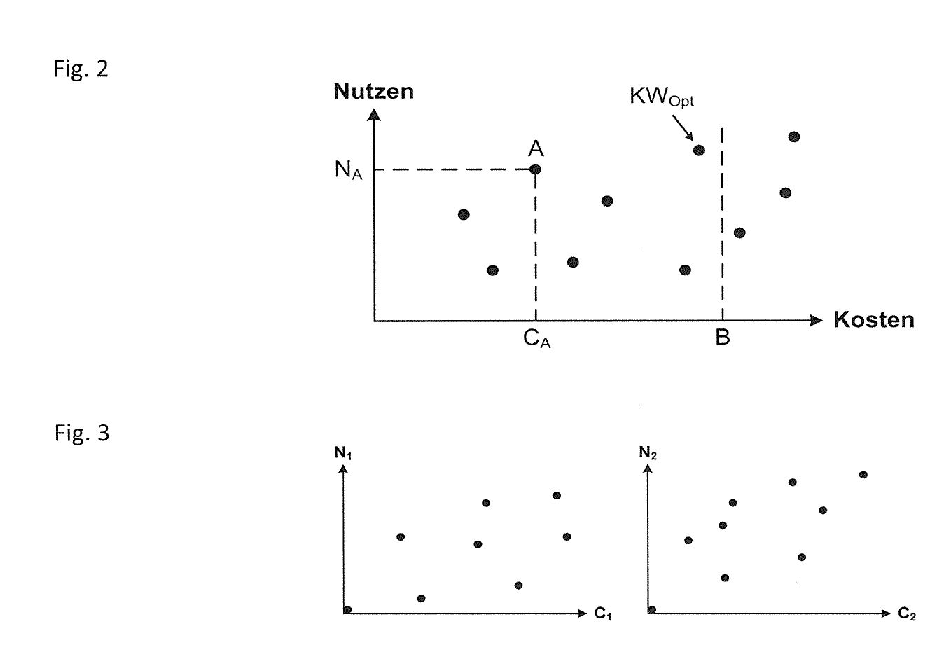

Each combination of modes of operation can be graphically represented as a point in a two-dimensional space, wherein the first coordinate indicates the total resource usage C(KW) of the combination KW of modes of operation, and the other coordinate indicates the benefit N(KW) that is produced. In FIG. 2 this is represented schematically. The combination of modes of operation A produces the total resource usage CA, and delivers the benefit NA.

The optimal combination of modes of operation KWₒₚₜ under a given total budget is defined as the combination that produces the maximum benefit N but whose costs do not exceed B. The corresponding optimization problem is:

$${KW}_{opt} = arg {max}_{KW ∈ {M}_{KW}} N ( KW )$$

with C(KW)≦B

This point is marked in FIG. 2

This optimization problem can be solved automatically if all possible combinations of modes of operation are specified. In cases with few modes of operation this is possible with enumeration methods. If the number #KW of possible combinations of modes of operation is too large, heuristic discrete optimization methods can be used to arrive at a good solution in a reasonable about of time.

A particularly important embodiment of the approximate solution of this optimization problem can be applied if both resource usage and benefits are given as linear combinations of individual usages Cᵢ(jᵢ) or individual benefits Nᵢ(jᵢ), and the modes of operation for the individual operating assets can be selected independently from each other:

$$C ( KW ) = {C}_{0} + {\sum }_{i = 1}^{N} {C}_{i} ( {j}_{i} )$$

$$N ( KW ) = {N}_{0} + {\sum }_{i = 1}^{N} {β}_{i} {N}_{i} ( {j}_{i} )$$

Therein KW is defined by the vector (j1, j₂, . . . , j_{N}). The weighting factors βᵢ>0 specify the influence that the sub-benefit Nᵢ(jᵢ) has on the total benefit N. C₀ corresponds to a baseline resource usage that is not dependent on the mode of operation, and N₀ corresponds to a baseline benefit that would be present even if all sub-benefits are zero.

Here the solution of the optimization problem from step 2a can start from a resource-benefit diagram for each individual operating asset, as is shown, e.g., in an exemplary way for only two operating assets in FIG. 3.

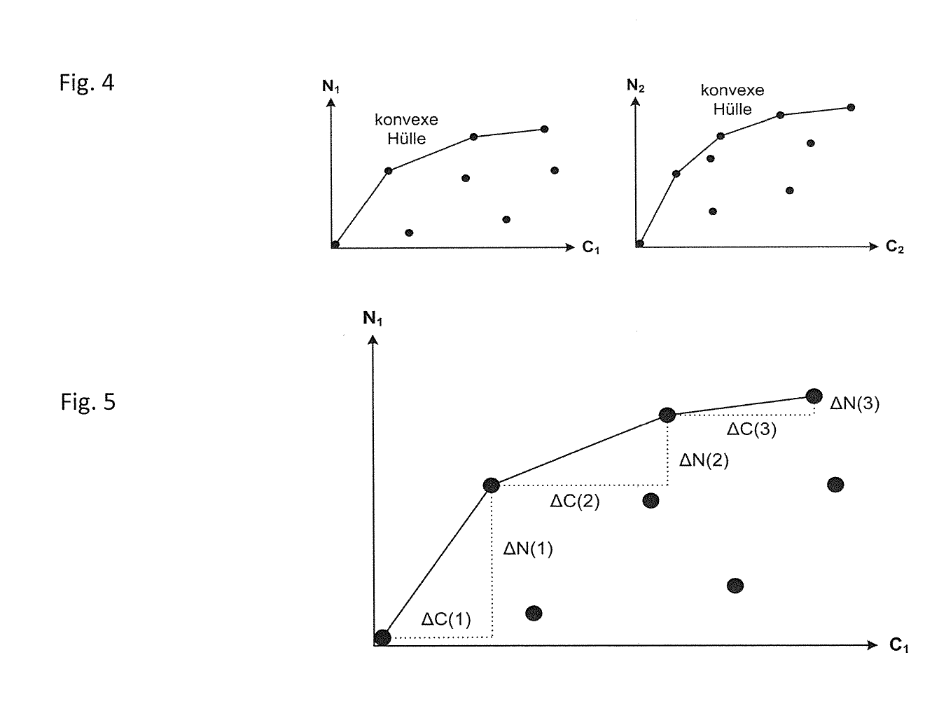

In a first step, for each operating asset all points are determined for the upper branch of the convex envelope (FIG. 4).

Next, for each operating asset the following steps are carried out:
1. Find the point on the upper convex envelope with the smallest resource usage (the point that lies as far as possible to the left).
2. Go rightwards to the next point on the convex envelope. Note the additional resource usage AC and the additional benefit AN.
3. Repeat step 2 until reaching the last point of the upper branch of the convex envelope.

As an example, this is represented in FIG. 5 for the first operating asset.

The result is a table of the following type for each operating asset:

Operating asset i

| | |
|---|---|
| ΔC(1) | ΔN(1) |
| ΔC(2) | ΔN(2) |
| ΔC(3) | ΔN(3) |
| ΔC(4) | ΔN(4) |

These tables are then assembled into a unified table for all operating assets and the table is sorted by the descending quotient ΔN/ΔC.

Subsequently the total budget is divided among the different operating assets. First, each operating asset is allocated an amount of resources so that the mode of operation with the smallest resource usage can be realized. Then, the remaining budget of resources is allocated stepwise according to the order of the table that is sorted by descending quotient ΔN/ΔC. First, the part ΔC of the uppermost entry is deducted from the budget. Thus, a benefit ΔN is reached as per the second column of that row. The process then proceeds to the second row, and so on, until the budget is used to such a degree that a further step would result in overspending.

Then the individual investments that correspond to the budget distribution steps are analyzed on the level of the individual operating assets and it is determined for each operating asset how much is invested there. The corresponding point in the cost-benefit diagram represents the optimal mode of operation of this operating asset.

A further variant for the same problem if both costs and benefits are formulated as linear combinations of individual costs or individual benefits, is:

$$C = {C}_{0} + {\sum }_{i = 1}^{N} {α}_{i} {C}_{i} ( {j}_{i} )$$

$$N = {N}_{0} + {\sum }_{i = 1}^{N} {β}_{i} {N}_{i} ( {j}_{i} )$$

This is particularly advantageous when there are very many possible modes of operation for the operating assets. Then, the convex envelope is characterized by a very dense set of points.

In this embodiment, the points are interpolated in such a way that they yield a function with a continuous derivative. Spline interpolation can be used for this purpose. The allocation of the total budget to the different operating assets can then be done by means of the equimarginal principle:

$${\frac{\partial {N}_{i} ( {C}_{i} )}{\partial {C}_{i}} \vert}_{{C}_{i} = {B}_{i}} = γ , i = 1 , … , N$$

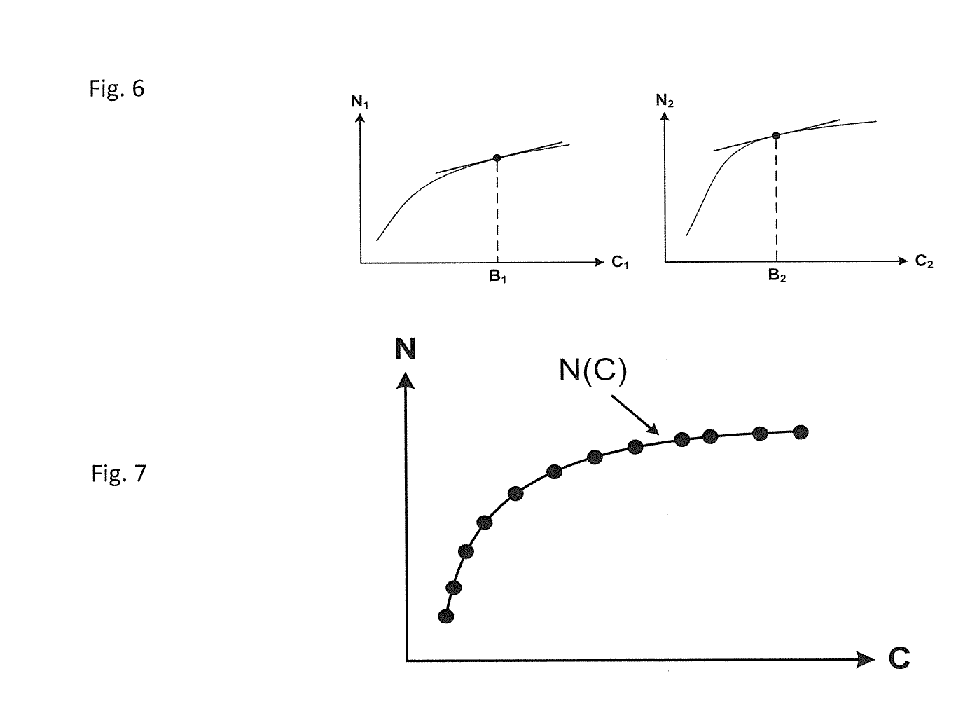

That is, the resource usage for each individual operating asset, also called sub-budget βᵢ, is set in such a way that the derivative of the utility function Nᵢ to Cᵢ is the same for all operating assets (FIG. 6).

The value of the derivative of the benefit according to cost is thus the same for all operating assets, and is denoted by y. The corresponding sub-budget is denoted by Bᵢ*.

The optimal mode of operation is now that real existent mode of operation that lies on the convex envelope, with a total resource budget as close as possible to Bᵢ*, but with C<Bᵢ*. The combination of all the modes of operation thus specified is the desired optimal combination of modes of operation.

Step 2b (Optimal Combination of Modes of Operation for a Predetermined Goal Total Benefit)

Step 2b is performed in a technically analogous way to step 2a. The roles of the quantities “resource usage” and “benefit” are simply exchanged, and the calculations carried out as described in step 2a.

Step 3 (Determination of the Operating Points of the Facilities' Portfolio)

In the case that neither total resource usage nor desired benefit are fixed in advance, there is no clear solution to the question of the optimal mode of operation. The portfolio owner has the freedom to select the resource usage within certain limits, or freely designate the benefit within certain limits.

Therefore, in step 3 of the method, step 2 is repeated multiple times. In one case, the benefit-maximizing combinations of modes of operation are determined for different total resource budgets in the interval of interest, and for each total budget C the benefit N achieved thereby is noted (repetition of step 2a). In another case, one varies the predetermined benefits within the interval of interest and for each case determines the optimal combination of modes of operation that achieves the benefit with minimal resource usage (repetition of step 2b).

Subsequently, the points thereby determined (C,N) are applied to the resource usage-benefit space. The points can be connected with a line to aid comprehension, or otherwise suitably interpolated. With a sufficiently fine resolution of the independent parameter, a function N(C) can thus be determined that represents the dependence of the total benefit on the total resource usage, under the assumption that the available resources are in each case used optimally (i.e., maximizing benefits).

According to an aspect of the invention the support of the user's decision is therefore achieved by a visualization of the interdependence between benefit and resource usage.

FIG. 7 shows an example of such a function N(C).

With the help of this function, the user can review at a glance the different options in the dimensions of benefits and resource usage. The diagram provides an optimal representation of the top-level properties of the operating assets portfolio in terms of the resources to be used and the benefits achievable thereby. Together with other aspects that are discussed in a cost-benefit analysis, the optimal operating point of the total portfolio can be set.

A portfolio of two operating assets is used to illustrate the method. The possible modes of operation of the two operating assets are characterized by a freely selectable service life T and a maintenance strategy R, wherein only two maintenance strategies are possible, which are described, respectively, by R=0 and R=1. Specifically, with R=1 a revision of the operating asset is carried out after 10 years, with R=0 this revision is omitted.

The resource usage is measured in monetary units, and indeed in average costs per year, averaged over the entire life cycle. The benefit is the negative of a weighted sum of the failure rate, also averaged over the entire life cycle.

Step 1: Specification

A mode of operation of an individual operating asset is specified by a tuple (T,R) wherein the interval of interest of T is between 5 and 40 years, and R can take the values R=0 or R=1.

A combination of modes of operation KW is correspondingly described by the specification of the two modes of operation:

KW=((T₁,R₁),(T₂,R₂))

As an example,

KW=((20,0), (40,1))

shows a combination of modes of operation in which operating asset 1 has a service life of 20 years and is not revised, and operating asset 2 has a service life of 40 years, but will be revised after 10 years.

The total benefit of the portfolio is given by a sum of sub-benefits:

N=N₁(T₁,R₁)+N₂(T₂,R₂)

where the sub-benefit is the negative of a weighted average failure rate

Nᵢ(Tᵢ,Rᵢ)=−wᵢ· h̅ᵢ̅(̅T̅ᵢ̅,̅R̅ᵢ̅)̅

wherein wᵢ denotes a weighting and h̅ᵢ̅(̅T̅ᵢ̅,̅R̅ᵢ̅)̅ the averaged failure rate over the life cycle.

The total resource usage is given as the sum of operating assets costs:

C=C₁(T₁,R₁)+C₂(T₂,R₂)

The unit of costs is thus “monetary units/year” and the unit of the benefit is “failures/year”.

The technical performance of the operating assets is mapped by the following aging function:

$${h}_{i} ( t , {R}_{i} ) = {a}_{i} + {b}_{i} \cdot t - \{ \begin{matrix}{c}_{i} , & if t > 10 and {R}_{i} = 1 \\ 0 , & otherwise\end{matrix}$$

The failure rate hᵢ(t,Rᵢ) has the unit [1/year] and consists of an offset a and increases linearly with the age of the operating assets. Moreover, the failure rate is dependent on the chosen revision strategy. If a revision is carried out (Rᵢ=1), then the failure rate after the revision is reduced to c. The average failure rate that results over a specified service life Tᵢ is thus:

$$\overline{{h}_{i} ( {T}_{i} , {R}_{i} )} = \frac{1}{{T}_{i}} {\sum }_{t = 1}^{{T}_{i}} {a}_{i} + {b}_{i} \cdot t - \{ \begin{matrix}{c}_{i} , & if t > 10 and {R}_{i} = 1 \\ 0 , & otherwise\end{matrix}$$

The average costs per year are defined in the following way:

$${C}_{i} ( {T}_{i} , {R}_{i} ) = \frac{1}{{T}_{i}} ( {I}_{i} + \{ \begin{matrix}{M}_{i} , & if t > 10 and {R}_{i} = 1 \\ 0 , & otherwise\end{matrix} ) + \overline{{h}_{i} ( {T}_{i} , {R}_{i} )} \cdot {D}_{i}$$

where:
Iᵢ the investment costs for the operating asset i.
Mᵢ the revision costs for the operating asset I (at an age of 10 years).
Dᵢ the costs that occur per failure.

The following parameters are valid for the two operating assets:

| Parameter | Operating asset 1 | Operating asset 2 |
|---|---|---|
| Acquisition costs Iᵢ | 20,000 | 30,000 |
| Revision costs Mᵢ | 10,000 | 10,000 |
| Costs per failure Dᵢ | 2,000 | 2,000 |
| Aging parameter aᵢ | 0.01 | 0.02 |
| Aging parameter bᵢ | 0.01 | 0.04 |
| Aging parameter cᵢ | 0.04 | 0.3 |
| Importance wᵢ | 1 | 5 |

The set of possible modes of operation for each of the two operating assets is defined by the space of the combinations of modes of operation, spanned by 5≦Tᵢ≦40 and Rᵢ∈{0,1} . The following table provides an excerpt from the list of possible combinations of modes of operation:

| Operating | | | | | |
|---|---|---|---|---|---|
| asset | Rᵢ | Tᵢ | h̅(̅T̅ᵢ̅,̅R̅ᵢ̅)̅ | C(Tᵢ,Rᵢ) | N(Tᵢ,Rᵢ) |
| 1 | 0 | 5 | 0.040 | 4080.00 | −0.040 |
| 1 | 0 | 10 | 0.065 | 2130.00 | −0.065 |
| 1 | 0 | 20 | 0.115 | 1230.00 | −0.115 |
| 1 | 0 | 30 | 0.165 | 996.67 | −0.165 |
| 1 | 0 | 40 | 0.215 | 930.00 | −0.215 |
| 1 | 1 | 5 | 0.040 | 4080.00 | −0.040 |
| 1 | 1 | 10 | 0.065 | 2130.00 | −0.065 |
| 1 | 1 | 20 | 0.095 | 1690.00 | −0.095 |
| 1 | 1 | 30 | 0.138 | 1276.67 | −0.138 |
| 1 | 1 | 40 | 0.185 | 1120.00 | −0.185 |
| 2 | 0 | 5 | 0.140 | 6280.00 | −0.700 |
| 2 | 0 | 10 | 0.240 | 3480.00 | −1.200 |
| 2 | 0 | 20 | 0.440 | 2380.00 | −2.200 |
| 2 | 0 | 30 | 0.640 | 2280.00 | −3.200 |
| 2 | 0 | 40 | 0.840 | 2430.00 | −4.200 |
| 2 | 1 | 5 | 0.140 | 6280.00 | −0.700 |
| 2 | 1 | 10 | 0.240 | 3480.00 | −1.200 |
| 2 | 1 | 20 | 0.290 | 2580.00 | −1.450 |
| 2 | 1 | 30 | 0.440 | 2213.33 | −2.200 |
| 2 | 1 | 40 | 0.615 | 2230.00 | −3.075 |

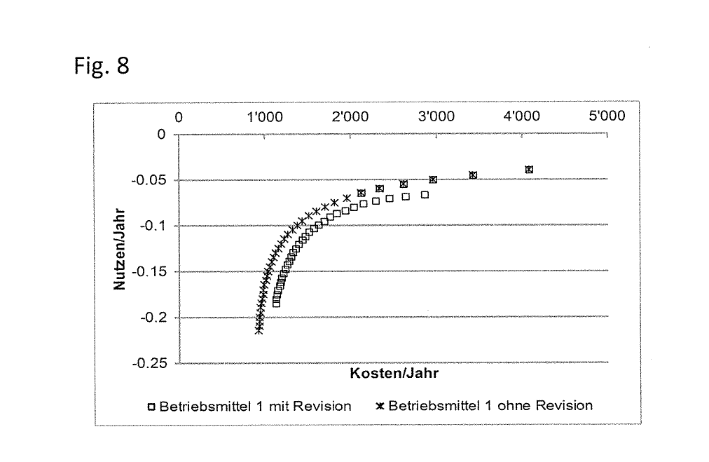

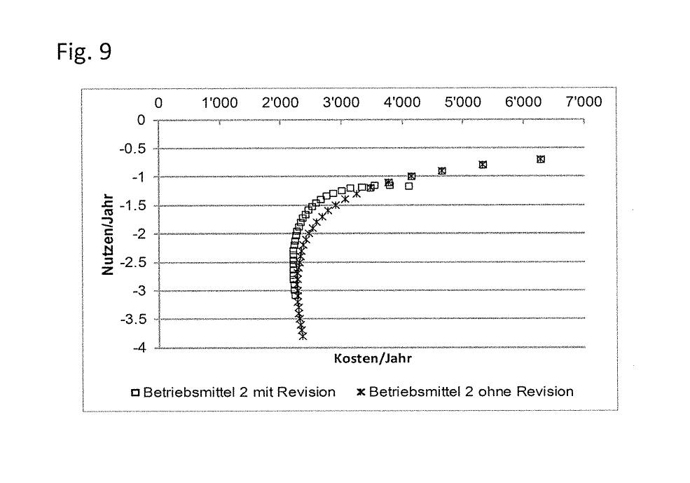

A representation of the sub-costs (or sub-resource usages) and sub-benefits of the two operating assets for different modes of operation can be seen in FIG. 8 for operating asset 1 and in FIG. 9 for operating asset 2, respectively. They show the average costs and benefits per year for all modes of operation of operating asset 1 and 2, respectively, wherein the revision strategies are differentiated: stars correspond to R=0 and squares to R=1. The different stars or squares correspond to different service lives T.

Step 2a:

In this example a benefit optimization is carried out for a predetermined total budget. The embodiment used is based on the convex envelope of the individual modes of operation.

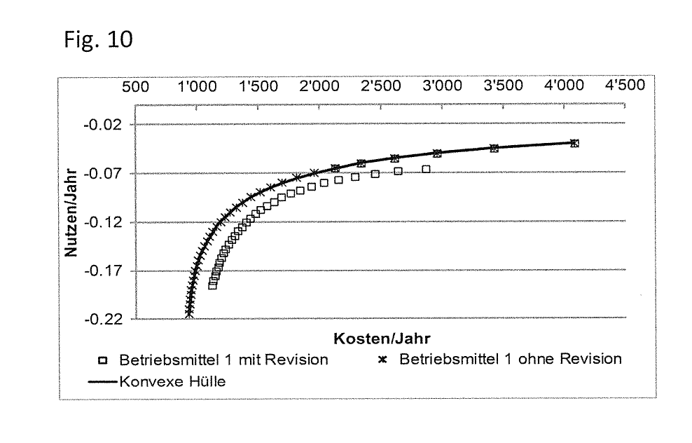

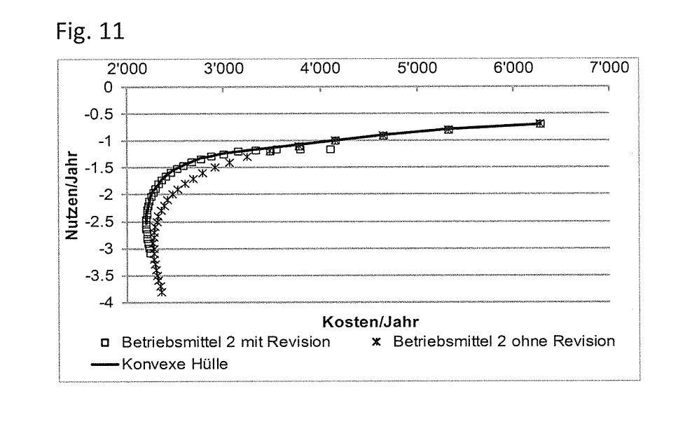

The results of the calculations of the convex envelope are seen in FIGS. 10 and 11. In FIG. 10 the convex envelope of operating asset 1 is visualized. Modes of operation lying on the convex envelope are exclusively of the maintenance strategy “no revision” (R=0). FIG. 11 shows the convex envelope of operating asset 2. The points of the convex envelope all correspond to modes of operation with R=1. However, just before and after the revision, some service lives do not lie on the convex envelope. Therefore, these are not considered further. It can further be observed that with long service lives (Tᵢ>34) the average costs per year rise again and thus these modes of operation also do not lie on the upper branch of the convex envelope.

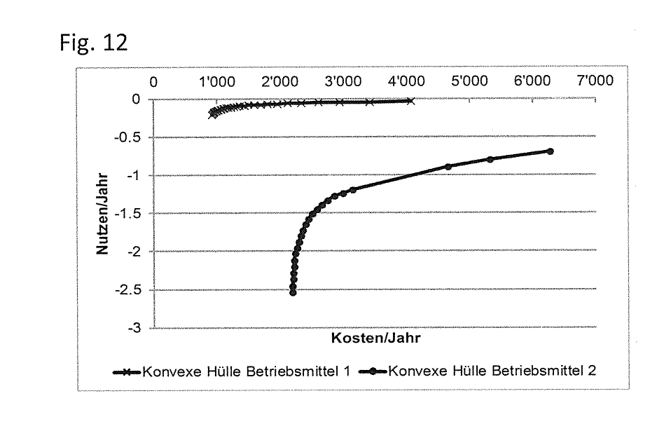

The convex envelopes of the two operating assets are represented in FIG. 12 in combination.

To identify the optimal modes of operation, in a first step the mode of operation with the lowest costs is selected for both operating assets. These are the modes of operation furthest to the left in FIG. 12 and they have the following characteristics:

| Operating | | | | |
|---|---|---|---|---|
| asset | Rᵢ | Tᵢ | C(Tᵢ,Rᵢ) | N(Tᵢ,Rᵢ) |
| 1 | 0 | 40 | 930 | −0.215 |
| 2 | 1 | 34 | 2193 | −2.541 |

The minimal costs for the entire portfolio are thus 930+2′193=3′123 monetary units per year and deliver a benefit of −2.755. If a larger total budget becomes available, more cost-intensive modes of operation can be selected and the benefit of the portfolio increased. Below a table is represented, which quantifies the deltas of costs and benefits to the corresponding mode of operation and thus the resulting gradient y (sorted in descending order by y) as well as the resulting costs and benefits for the portfolio:

| Operating asset | Rᵢ | Tᵢ | ΔC (Tᵢ, Rᵢ) | ΔN (Tᵢ, Rᵢ) | y | C | N |
|---|---|---|---|---|---|---|---|
| 2 | 1 | 33 | 0.99821747 | 0.08663102 | 0.08678571 | 3124 | −2.668 |
| 2 | 1 | 32 | 3.56060606 | 0.08579545 | 0.02409574 | 3128 | −2.583 |
| 2 | 1 | 31 | 6.37096774 | 0.08487903 | 0.01332278 | 3134 | −2.498 |
| 2 | 1 | 30 | 9.46236559 | 0.08387097 | 0.00886364 | 3143 | −2.414 |
| 2 | 1 | 29 | 12.8735632 | 0.08275862 | 0.00642857 | 3156 | −2.331 |
| 2 | 1 | 28 | 16.6502463 | 0.08152709 | 0.00489645 | 3173 | −2.25 |
| 2 | 1 | 27 | 20.8465608 | 0.08015873 | 0.00384518 | 3194 | −2.169 |
| 2 | 1 | 26 | 25.5270655 | 0.07863248 | 0.00308036 | 3219 | −2.091 |
| 2 | 1 | 25 | 30.7692308 | 0.07692308 | 0.0025 | 3250 | −2.014 |
| 2 | 1 | 24 | 36.6666667 | 0.075 | 0.00204545 | 3287 | −1.939 |
| 1 | 0 | 39 | 2.82051282 | 0.005 | 0.00177273 | 3290 | −1.934 |
| 2 | 1 | 23 | 43.3333333 | 0.07282609 | 0.0016806 | 3333 | −1.861 |
| 1 | 0 | 38 | 3.49527665 | 0.005 | 0.0014305 | 3336 | −1.856 |
| 2 | 1 | 22 | 50.9090909 | 0.07035573 | 0.00138199 | 3387 | −1.786 |
| 1 | 0 | 37 | 4.22475107 | 0.005 | 0.0011835 | 3392 | −1.781 |
| 2 | 1 | 21 | 59.5670996 | 0.06753247 | 0.00113372 | 3451 | −1.713 |
| 1 | 0 | 36 | 5.01501502 | 0.005 | 0.00099701 | 3456 | −1.708 |
| 2 | 1 | 20 | 69.5238095 | 0.06428571 | 0.00092466 | 3526 | −1.644 |
| 1 | 0 | 35 | 5.87301587 | 0.005 | 0.00085135 | 3531 | −1.639 |
| 2 | 1 | 19 | 81.0526316 | 0.06052632 | 0.00074675 | 3613 | −1.578 |
| 1 | 0 | 34 | 6.80672269 | 0.005 | 0.00073457 | 3619 | −1.573 |
| 1 | 0 | 33 | 7.82531194 | 0.005 | 0.00063895 | 3627 | −1.568 |
| 2 | 1 | 18 | 94.502924 | 0.05614035 | 0.00059406 | 3722 | −1.512 |
| 1 | 0 | 32 | 8.93939394 | 0.005 | 0.00055932 | 3731 | −1.507 |

It can be seen that, initially, investment is exclusively in operating asset 2, until its service life is reduced from 34 to 24 years. Only at that point investments are made in operating asset 1. For a budget of 3,392 money per year a benefit of −1.781 results and for the two operating assets the following mode of operation is selected:
Operating asset 1: 37 year service life, no revision
Operating asset 2: 22 year service life, with revision

Step 2 is achieved by this procedure.

Step 3:

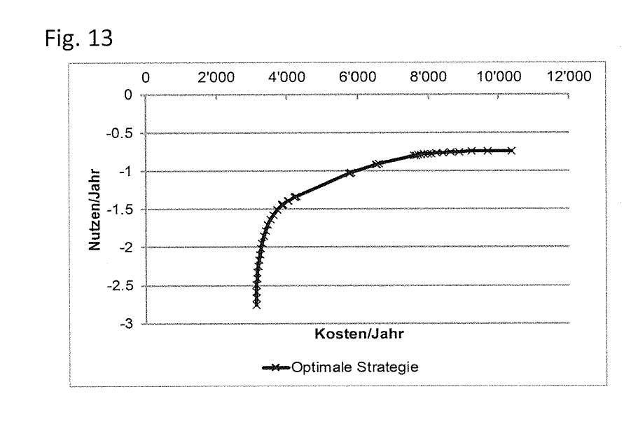

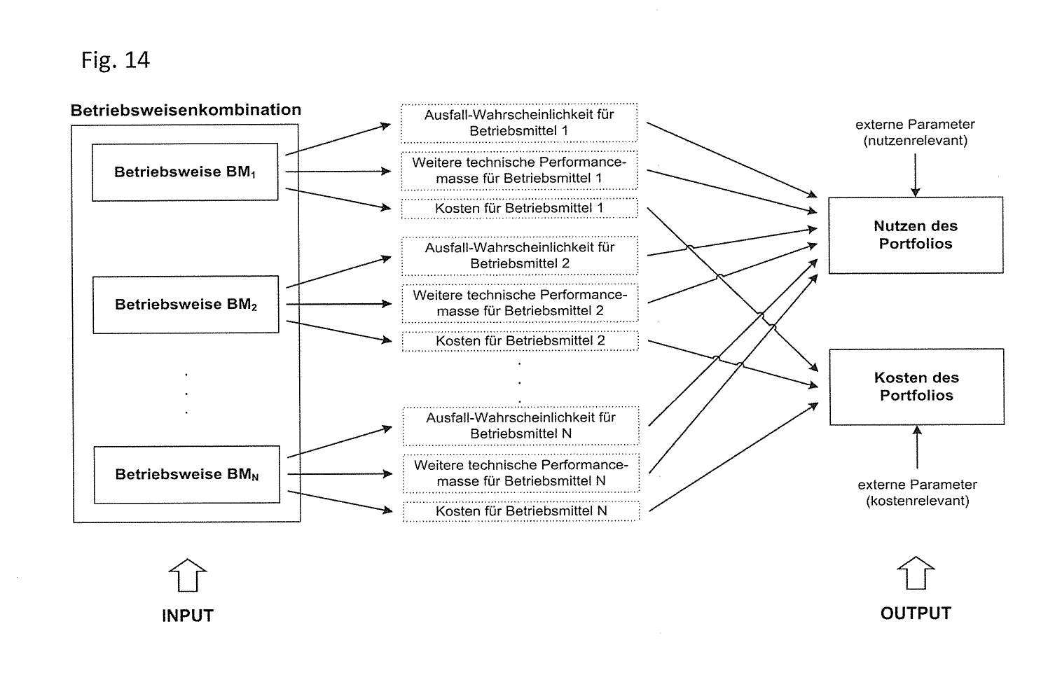

The table above is also the basis for step 3 of the method. The last two columns contain the information about the costs and benefits of the portfolio, which are compared with one another in a graph (FIG. 13).

Based on a representation like that in FIG. 13 the discussion of the optimal use of the budget can be conducted on a higher level. Depending on the decision about the amount of the total budget, the optimal modes of operation for each individual asset in the portfolio are defined.

1. A computer-aided method for determining the optimal modes of operation of operating assets in a portfolio of a plurality of technical operating assets; wherein the following steps are carried out by a data-processing system comprised of at least one computing device, a means to store electronic data and information, a computer-readable medium containing executable program instructions, and at least one display device; the method comprising the steps of:
a. Step 1:
i. Define a set of possible combinations of modes of operation for the portfolio of operating assets, wherein this set is a sub-set of all possible combinations of different modes of operation of the individual operating assets;
ii. Define a failure function which expresses a failure or malfunction rate of all the operating assets over time, dependent upon a chosen combination of modes of operation;
iii. Define a utility function for the portfolio that assigns a total benefit to each combination of modes of operation, wherein the total benefit depends at least on the failure rate of the operating assets; and
iv. Define a cost function for the portfolio that assigns a total resource usage to each combination of modes of operation.
b. Step 2:
i. Solve an optimization problem to determine an optimal combination of modes of operation, by either
Maximizing the total benefit of the portfolio, under the constraint that a given total resource usage not be exceeded (hereinafter, step 2a), Or
Minimizing the resource usage, under the constraint that the total benefit of the portfolio does not fall short of a specified value (hereinafter step 2b); and
ii. Display, by means of an output device, the optimal combination of modes of operation as a solution of the optimization problem, wherein the respective optimal mode of operation is made visible for each operating asset.

2. The method according to claim 1, comprising an additional Step 3, in which:
either
step 2a is performed for different predetermined total resource usage values C, and each total benefit N that is achieved with the optimal combination of modes of operation is stored; or
step 2b is performed for different values N of the predetermined total benefit, and the total resource usage C that is achieved with the optimal combination of modes of operation is stored; and
the value pairs (C,N) are depicted graphically or in a table in a two-dimensional resource usage-benefit space by means of a display device, whereby the interdependence of resource usage and benefits is shown.

3. The method according to claim 1, wherein in sub-Step 1 ii) further comprises the actions of:
Define technical performance metrics; and
Integrate said technical performance metrics in at least one of the utility and the resource usage function.

4. The method according to claim 2, wherein a function N(C) that specifies the dependence of the total benefit on the resource usage C is determined from the value pairs (C,N).

5. The method according to claim 1, wherein, for displaying the solution of the optimization problem, the set of all combinations of modes of operation is depicted as points in a resource usage-benefit space.

6. The method according to claim 1, wherein, in displaying the solution of the optimization problem for some or all operating assets, the set of all modes of operation for the respective operating asset is depicted as points in a resource usage-benefit space.

7. The method according to claim 1, wherein, in displaying the resource usage-benefit behavior of individual operating assets for some or all operating assets, the upper branch of the convex envelope of those points is depicted, which result when all modes of operation of the respective operating asset are depicted in a sub-resource-usage-benefit space.

8. The method according to claim 2, wherein, after depicting the dependence of resource usage and benefit, the method further comprises performing the following:
Define a maximum permissible resource usage; and
Then determine and display an optimal combination of modes of operation for this usage using the method from claim 1.

9. The method according to claim 1, wherein, after depicting the dependence of resource usage and benefit, the method further comprises performing the following:
Define a minimum acceptable benefit; and
Then determine and display an optimal combination of modes of operation for this benefit using the method from claim 1.

10. The method according to claim 1, wherein resource usage and benefit are defined as time averages of a long-term consumption or benefit trend of the portfolio.

11. The method according to claim 1, wherein resource usage or benefit are defined as discounted sums of a long-term consumption or benefit trend of the portfolio.

12. The method according to claim 1, wherein the utility function is an additive function of a sub-benefit that is defined for each operating asset and can be weighted with a weighting factor.

13. The method according to claim 1, wherein the resource usage is an additive function of individual resource usages of the individual operating assets.

14. The method according to claim 1, wherein the benefit of the portfolio is a linear function of the failure rates of the operating assets.

15. The method according to claim 1, wherein the determined optimal combination of modes of operation is applied to the technical operating assets for implementation.

16. A data-processing system for determining the optimal modes of operation of operating assets in a portfolio of a plurality of technical operating assets, wherein the data processing system comprises:
at least one computing device;
a means to store electronic data and information;
at least one display device; and
a computer-readable medium containing executable program instructions to execute a method comprising the steps of:
a. Step 1:
i. Define a set of possible combinations of modes of operation for the portfolio of operating assets, wherein this set is a sub-set of all possible combinations of different modes of operation of the individual operating assets:
ii. Define a failure function which expresses a failure or malfunction rate of all the operating assets over time, dependent upon a chosen combination of modes of operation;
iii. Define a utility function for the portfolio that assigns a total benefit to each combination of modes of operation, wherein the total benefit depends at least on the failure rate of the operating assets; and
iv. Define a cost function for the portfolio that assigns a total resource usage to each combination of modes of operation.
b. Step 2:
i. Solve an optimization problem to determine an optimal combination of modes of operation, by either
Maximizing the total benefit of the portfolio, under the constraint that a given total resource usage not be exceeded (hereinafter, step 2a), Or
Minimizing the resource usage, under the constraint that the total benefit of the portfolio does not fall short of a specified value (hereinafter step 2b); and
ii. Display, by means of an output device, the optimal combination of modes of operation as a solution of the optimization problem, wherein the respective optimal mode of operation is made visible for each operating asset.

17. A computer-readable medium containing a computer program for determining optimal modes of operation of operating assets in a portfolio of a plurality of technical operating assets, which is able to be loaded and executed on a data-processing unit, and which when executed implements the method comprising the steps of:
a. Step 1:
i. Define a set of possible combinations of modes of operation for the portfolio of operating assets, wherein this set is a sub-set of all possible combinations of different modes of operation of the individual operating assets;
ii. Define a failure function which expresses a failure or malfunction rate of all the operating assets over time, dependent upon a chosen combination of modes of operation;
iii. Define a utility function for the portfolio that assigns a total benefit to each combination of modes of operation, wherein the total benefit depends at least on the failure rate of the operating assets; and
iv. Define a cost function for the portfolio that assigns a total resource usage to each combination of modes of operation.
b. Step 2:
i. Solve an optimization problem to determine an optimal combination of modes of operation, by either
Maximizing the total benefit of the portfolio, under the constraint that a given total resource usage not be exceeded (hereinafter, step 2a), Or
Minimizing the resource usage, under the constraint that the total benefit of the portfolio does not fall short of a specified value (hereinafter step 2b); and
ii. Display, by means of an output device, the optimal combination of modes of operation as a solution of the optimization problem, wherein the respective optimal mode of operation is made visible for each operating asset.

18. The system according to claim 16, comprising additional executable program instructions to perform an additional Step 3, in which:
either
step 2a is performed for different predetermined total resource usage values C, and each total benefit N that is achieved with the optimal combination of modes of operation is stored; or
step 2b is performed for different values N of the predetermined total benefit, and the total resource usage C that is achieved with the optimal combination of modes of operation is stored; and
the value pairs (C,N) are depicted graphically or in a table in a two-dimensional resource usage-benefit space by means of a display device, whereby the interdependence of resource usage and benefits is shown.

19. The system according to claim 16, wherein in sub-Step 1 ii) further comprises the executable program sub-Step 1 ii) actions of:
Define technical performance metrics; and
Integrate said technical performance metrics in at least one of the utility function and the resource usage function.

20. The computer-readable medium according to claim 17, comprising additional computer program instructions to perform an additional Step 3, in which:
either
step 2a is performed for different predetermined total resource usage values C, and each total benefit N that is achieved with the optimal combination of modes of operation is stored; or
step 2b is performed for different values N of the predetermined total benefit, and the total resource usage C that is achieved with the optimal combination of modes of operation is stored; and
the value pairs (C,N) are depicted graphically or in a table in a two-dimensional resource usage-benefit space by means of a display device, whereby the interdependence of resource usage and benefits is shown.

21. The method according to claim 15, wherein said technical operating assets include one or more of the following: an infrastructure network, an electrical power-supply facility, an electrical-grid network, a water-supply facility, a water-supply network, a supply of energy, a rail network, a street network, and an industrial production facility.
